(19) United States
(12) Patent Application Publication
(10) Pub. No.: US 2026/0370072 A1
(43) Pub. Date: Nov. 19, 2026

(54) PERMANENT MAGNET MOTOR

(71) Applicant: Peter Grandics, Carlsbad, CA (US)

(72) Inventor: Peter Grandics, Carlsbad, CA (US)

(21) Appl. No.: 19/137,578

(22) PCT Filed: Dec. 18, 2023
(86) PCT No.: PCT/US2023/084546

§ 371 Date: Jun. 10, 2025

Related U.S. Application Data
(60) Provisional application No. 63/387,740, filed on Dec. 16, 2022.

(51) Int. Cl. H02K 1/27; H02K 1/16; H02K 7/09; H02K 11/049; H02K 53/00

(52) U.S. Cl. CPC H02K 1/27; H02K 1/16; H02K 7/09; H02K 11/049; H02K 53/00

(57) ABSTRACT

A permanent magnet motor is disclosed. The motor may include: a permanent magnet rotor placed on a shaft having magnetic disks at the ends of the shaft. The magnetic disks may be disposed at the shaft ends and may be facing two fixed driver magnets of opposing polarity. The driver magnets may also serve as core for electromagnets. The magnetic interactions of the magnetic disks and the driver magnets leads to a spontaneous acceleration of the rotor. The rotor magnet may spin inside a stator having windings for generating alternating current (AC) electricity. The AC electricity after rectification may be fed back to the two electromagnets generating exponentially increasing magnetic fields and revolutions for the rotor. A load circuit may regulate the rotation speed of the rotor.

### PRIORITY

This application is a national stage application, filed under 35 U.S.C. § 371, of International Patent Application No. PCT/US23/84546, filed Dec. 16, 2022 and entitled “PERMANENT MAGNET MOTOR”, which claims the benefit of priority to U.S. Provisional Patent Application Ser. No. 63/387,740 filed Dec. 16, 2022 and entitled “PERMANENT MAGNET MOTOR”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of energy generation. More particularly, the present disclosure relates to energy generation using a permanent magnet motor.

### DESCRIPTION OF RELATED TECHNOLOGY

Electricity is incredibly useful and plays a crucial role in modern society. Its applications are vast and diverse, impacting various aspects of our daily lives, industries, and technological advancements. For example, electricity is the primary source of energy for lighting, heating, cooling, and powering electronic devices in homes and businesses. It enables us to run appliances, charge devices, and enjoy modern conveniences. Electric power is increasingly being used in transportation, with electric cars, buses, trains, and bicycles becoming more common. Recently, a shift toward electric transportation helps reduce dependence on fossil fuels and lowers environmental impact.

Despite its numerous benefits, there is a significant environmental impact in generating electricity, depending on the energy sources used. For example, fossil fuels (hydrocarbon-containing material such as coal, oil, and natural gas) are one of the primary sources of fuel for the production of energy. Burning fossil fuels to generate electricity, however, releases carbon dioxide they burn, thus accelerating climate change, as well as releasing particulate matter into the atmosphere contributing to smog and acid rain. Sustainable and renewable energy sources are therefore needed to mitigate these environmental concerns. Other concerns new energy sources may help address include energy security by reducing dependance on finite/non-renewable fossil fuel reserves, increasing access to energy, and long-term cost stability.

The adoption of renewable energy is a high priority for many countries and some countries have even mandated the use of renewable energy. Adoption, however, has been hampered by several factors including cost, reliability, and intermittent power output, and the inability to meet high surge demands of air conditioners, chillers and large power loads. Improvements to batteries for energy storage have been used to mitigate some of these problems. Batteries, however, are expensive, have a limited life, and present their own ecological costs due to hazardous materials in batteries that are often discarded and not properly (or unable to be) recycled.

The use of renewable energy is particularly significant in locations where utility service is unavailable, electricity costs are high, or are limited by fuel availability such as on islands or other remote locations, ships, or countries without fossil fuel resources. The use of renewables has applications as backup power and by militaries and governments. Reduced costs of electricity generation could also reduce the costs of heavy users of electricity including smelters, large pumping stations, water desalination plants, mines, etc.

Distributed generation refers to a variety of technologies that generate electricity at or near where it will be used, such as solar panels and combined heat and power. Distributed generation may serve a single structure, such as a home or business, or it may be part of a microgrid (a smaller grid that is also tied into the larger electricity delivery system), such as at a major industrial facility, a military base, or a large college campus. On-site power generation may play a role in distributed generation of power and may allow homes and businesses to not rely on external energy generation and transport which may lead to periods of price instability or an inability to meet demand (e.g., blackouts and brownouts) due to changes in fuel prices, natural disaster, war/terrorism, etc. Additionally, a significant fraction of the global population has no installed power and distributed power generation technologies may allow individuals or businesses to access electricity without relying on centralized power generation and power distribution infrastructure.

Magnets are objects that produce a magnetic field, an invisible force that attracts or repels certain materials. This magnetic field is created by the alignment of magnetic atoms or elementary particles within the material. There are different types of magnets, and they can be categorized into natural and artificial magnets. Magnets have two distinct poles: a north pole and a south pole. Like poles repel each other, and opposite poles attract each other. The region around a magnet where its magnetic influence is felt is known as the magnetic field.

Natural magnets are naturally magnetic materials, e.g., magnetite (also known as lodestone) and has been used since ancient times for navigation (e.g. as a compass) and other applications. The mysterious magnetic attraction and repulsion phenomena of lodestone has intrigued researchers who imagined using the properties of magnets for levitation and power generation. Such attempts have begun as early as the 13th century and continue to date.

Artificial magnets include ferromagnetic materials and electromagnets. Artificial magnets are created using materials that are inherently magnetic, such as iron, cobalt, and nickel. These materials maybe magnetized by exposing them to a strong external magnetic field. Once magnetized, they retain their magnetic properties to some extent even after the external field is removed. Electromagnets are artificial magnets created by passing an electric current through a coil of wire. This coil generates a magnetic field, and the strength of the magnetic field can be controlled by adjusting the current flow. Electromagnets are commonly used in various devices and applications, including electric motors, speakers, and magnetic locks.

### BRIEF DESCRIPTION OF THE DRAWINGS

FIG. 1 illustrates an exemplary system showing the placement of a suspended magnet and a fixed magnet.

FIG. 2 is a block diagram of an exemplary generator for producing electricity according to aspects of the present disclosure.

FIG. 3 is a cross-sectional view of an exemplary rescue bearing, as shown in FIG. 2.

FIG. 4 is a logical flow diagram of an exemplary method of operating a permanent magnet motor.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

For purposes of the description hereinafter, it is to be understood that the specific articles, compositions, and/or processes described herein are exemplary and should not be considered as limiting. In the description, relative terms such as “lower,” “upper,” “horizontal,” “vertical,”, “above,” “below,” “up,” “down,” “top,” “bottom,” “underside,” “front,” “rear,” and “side” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

According to aspects of the present disclosure, a generator is disclosed that uses magnets to induce current flow generating electricity. Use cases of aspects of the present disclosure include small (e.g., home/business use) and large scale (e.g., power plant) energy generation, energy generation in transportation (e.g., as part of an electric motor in an automobile, boat, or train), as well as smaller applications (powering toys, acting as an executive desk toy), etc. A low-power version of the present techniques may be used to power lighting or small appliances or charging rechargeable batteries.

In some examples, the system establishes conditions for a rotating body to be stably supported by passive magnetic bearings. Example systems may achieve a state of stable equilibrium in rotation with the aid of two additional magnetic elements positioned at the ends of a shaft. These magnetic elements are attracted by opposing (driver) magnets to provide axial stabilization as well as the driving force to cause rotation of the magnetically suspended rotor. The rotor may also have permanent magnets installed and is positioned inside a stator. The rotation of the rotor induces voltage in the stator's windings the output of which is connected thru a rectifier circuit to coils placed around the driver magnets. Placing a load inside the circuit regulates currents and ultimately the rotation of the shaft. The radially supporting passive magnetic bearings and the axially positioned driver magnets may keep the rotor in a state of dynamic equilibrium and ensure the uninterrupted supply of electricity.

In some examples, a magnet motor is disclosed for harvesting the stored energies of permanent magnets. The motor may include: a magnetically suspended permanent magnet rotor placed on a shaft having two magnetic disks at the ends of the shaft, the two magnetic disks at the shaft ends are facing two fixed driver magnets of opposing polarity that also serve as core for electromagnets, the magnetic interactions of the shaft-end magnetic disks and the driver magnets leads to a spontaneous acceleration of the rotor, rotor magnet spins inside a stator having windings for generating alternating current (AC) electricity, the AC electricity after rectification is fed back to the two electromagnets generating exponentially increasing magnetic fields and revolutions for the rotor, a load circuit regulates the rotation speed of the rotor. These motor assemblies can be stacked and their output power combined.

### 1 Magnets and Induced Rotation

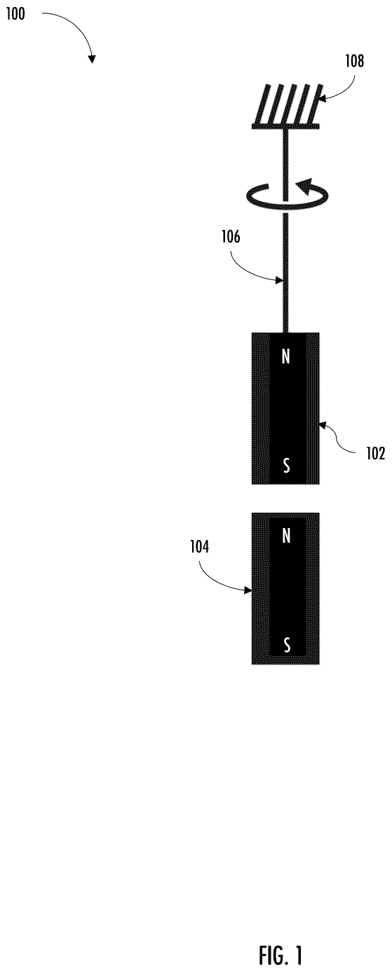

FIG. 1 illustrates an exemplary system 100 showing the placement of a suspended magnet 102 and a fixed magnet 104. This system 100 illustrates that between the opposing poles of two permanent magnets (the suspended magnet 102 and the fixed magnet 104) a rotational field may exist that can be tapped for motive power. The suspended magnet 102 is suspended via a filament 106 from an object 108. In some examples, the filament 106 may include a thread or wire (of a single or multiple twisted strands) of sufficient strength to hold the suspended magnet 102. The object 108 may include the ceiling, a housing, a cage or other support structure, or any fixed element that can support the weight of the filament 106 and the suspended magnet 102.

The fixed magnet 104 may be on the ground or on a platform. In some examples, the platform may be raised/lowered to position the fixed magnet 104 within a threshold distance of the suspended magnet. The threshold distance may be based on the sizes of magnets (suspended magnet 102 and fixed magnet 104).

In some examples, the suspended magnet 102 is a NdFeB (neodymium-iron) permanent magnet bar. The fixed magnet 104 may also be a NdFeB magnet. In some examples, the suspended magnet 102 and the fixed magnet 104 are cylindrical magnets with poles at the ends of the cylinder. In other examples, the suspended magnet 102 and the fixed magnet 104 can be of any shape (including different shapes). Further, in some examples the suspended magnet 102 and the fixed magnet 104 are the same size and strength (e.g., similar maximum energy product), however magnets with differing sizes and strengths may be used with equal success.

As shown, the suspended magnet 102 is suspended from the north (N) pole, via the filament 106, with the south(S) pole facing the fixed magnet 104. In other examples, the suspended magnet 102 may be suspended from the south (D) pole, via the filament 106, with the north (N) pole facing the fixed magnet 104. The suspended magnet 102 and the fixed magnet 104 are spontaneously positioned on a common axis of rotation.

In one example, the fixed magnet 104 is raised toward the suspended magnet 102. The suspended magnet 102 and the fixed magnet 104 and may each have a central axis which runs in the center of the suspended magnet 102/fixed magnet 104 between the north and south poles. The central axis of the fixed magnet 104 may spontaneously align with the axis of the suspended magnet 102 when the fixed magnet 104 is raised toward the suspended magnet 102, thus no net external forces affect this equilibrium (that would independently cause the rotation).

Upon crossing a threshold distance from the fixed magnet 104, the suspended magnet 102 may begin a spontaneous, accelerating rotation that lasts until the filament 106 is completely wound. The suspended magnet 102 may remain wound up until the fixed magnet 104 is removed demonstrating a torque by the fixed magnet 104. Specifically, remaining wound until the fixed magnet 104 is removed may illustrate that a torque exists between opposing poles of magnets (e.g., between the poles of the suspended magnet 102 and the fixed magnet 104).

Retracting the fixed magnet 104 beyond the threshold distance may stop rotation of the suspended magnet 102. For example, where a platform the fixed magnet 104 rests on is lowered away from the suspended magnet 102.

Some techniques may employ structures (e.g., a movable magnetic shield between the suspended magnet 102 and the fixed magnet 104) to break the symmetry between the suspended magnet 102 and the fixed magnet 104. However, examples of the present techniques do not use such structures to induce rotation. As a result of the spontaneous rotation of the suspended magnet 102, there may be no need to break the symmetry between the suspended magnet 102 and the fixed magnet 104.

Depending on the friction between the filament 106 and the object 108 the filament 106 is suspended from, the torque/rotational effect on the suspended magnet 102 may be small. This torque/rotational effect may be amplified via a positive feedback loop. A positive feedback loop may be created via a self-excitation circuit to amplify the torque. Placing an inductor around the suspended magnet 102 may generate electricity that can power a load.

### 2 Example Operation

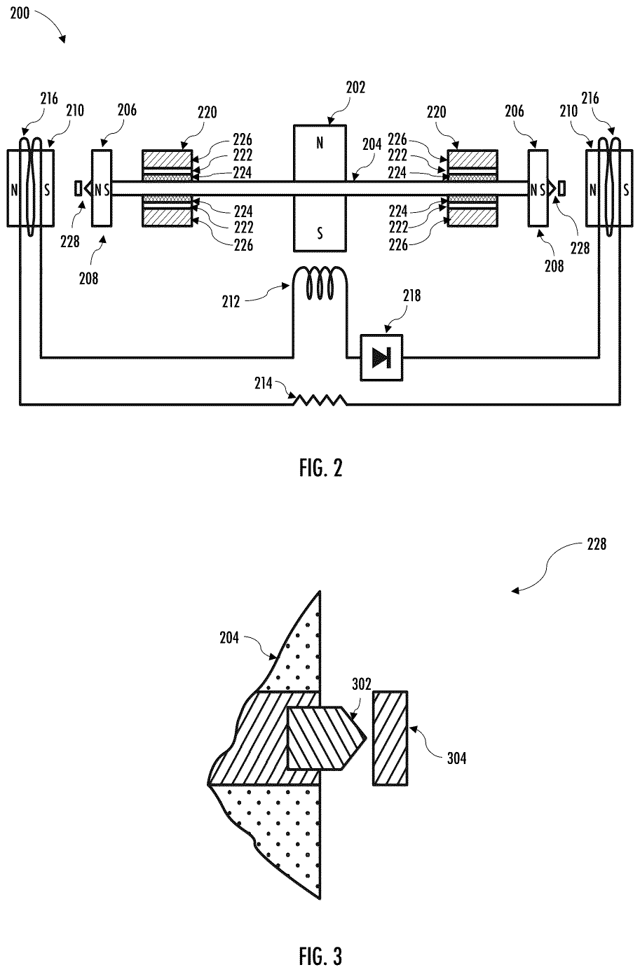

FIG. 2 is a block diagram of an exemplary generator 200 for producing electricity according to aspects of the present disclosure. A magnetic rotor 202 is positioned on a shaft 204. The shaft 204 and the magnetic rotor 202 are coupled such that the shaft 204 and the magnetic rotor 202 may rotate in tandem. Magnetic disks 206 may be positioned at each end 208 of the shaft 204 and may rotate in tandem with the shaft 204. The shaft 204 is stabilized allowing the shaft 204 (and coupled magnetic rotor 202/magnetic disks) to rotate about a central axis of the shaft 204 (e.g., pitch). The stabilization keeps the shaft 204 in fixed in place for other degrees of movement (e.g., roll, yaw, and translational movement). Driver magnets 210 positioned at each end 208 of the shaft 204 may induce rotation in the magnetic disks 206. This causes the shaft 204 and magnetic rotor 202 to rotate. The rotation of the magnetic rotor 202 may induce a current in a stator coil 212. The induced current may power a load 214.

The shaft 204 may be configured to transmit mechanical power to the magnetic rotor 202. The shaft 204 may be capable of withstanding the mechanical stresses imposed during operation of the generator 200. The shaft 204 may be constructed from titanium, or other suitable non-magnetizable material that can withstand operation (e.g., the torque and speed) of the generator 200. For smaller/low-power applications, the shaft 204 may be constructed from plastics. In some examples, the shaft 204 may be a cylindrical shape. In further examples, each end 208 of the shaft 204 has a conical point.

Magnetic disks 206 may be disposed at each end 208 of the shaft 204. In some examples, the magnetic discs 206 facing opposite polarity from each other. For example, as illustrated in FIG. 2, one end 208 of the shaft 204 has a magnetic disk 206 with the north pole facing away from the center of the shaft 204/magnetic rotor 202 and the other end 208 of the shaft 204 has a magnetic disk 206 with the south pole facing away from the center of the shaft 204/magnetic rotor 202.

Driver magnets 210 may induce rotation in the magnetic disks 206, which in turn causes the magnetic rotor 202 to rotate. In some examples, the driver magnets 210 are permanent magnets. In some examples, coiled wires 216 surround the permanent magnets. The coiled wires 216 may be electrically coupled to the stator coil 212 such that electricity/induced current flows through the coiled wires from the stator coil 212. An electromagnet may be created (that has a stronger strength than the permanent magnet) when electricity flows through the coiled wires 216. The electricity may include direct current received from a rectification circuit 218. The electromagnet has an increased magnetic field compared to the permanent magnet alone and therefore the driver magnets 210 are able to increase the amount of rotation induced in the magnetic disks 206.

The polarity of a driver magnet 210 may face the side of the magnetic disk 206 with the opposing polarity. For example, where the north pole of the magnetic disk 206 faces away from the center of the shaft 204/magnetic rotor 202, the driver magnet 210 may be positioned with the south pole facing the driver magnet 210. Similarly, where the south pole of the magnetic disk 206 faces away from the center of the shaft 204/magnetic rotor 202, the driver magnet 210 may be positioned with the north pole facing the driver magnet 210. Accordingly, the driver magnets 210 provides axial stability to the shaft 204/magnetic rotor 202 assembly positioned at the two ends 208 of the shaft 204. Further, the driver magnets 210 and the magnetic disks 206 may have a common axis of rotation.

The driver magnets 210 may be movable towards and away from the shaft 204, magnetic rotor 202, and/or magnetic disks 206. The driver magnets 210 may be movable along the axis of rotation of the shaft 204. When the driver magnets 210 are moved toward the shaft 204 and cross a threshold distance from a magnetic disk 206, the magnetic disk 206 begins spontaneous and accelerating rotation in response to the driver magnets 210. This rotation, in turn, causes the shaft 204 and the magnetic rotor 202 to rotate. Similarly, upon crossing beyond the threshold distance when retracting the driver magnets 210 from the magnetic disks 206, the spontaneous and/or accelerating rotation of the magnetic disks 206 may stop/slow. In turn, this causes the shaft 204 and the magnetic rotor 202 to decelerate/stop rotating.

As shown, examples of generator 200 includes two magnetic disks and two driver magnets 210 on each side of the shaft 204. In other examples, only a single driver magnet 210 is used to rotate a single magnetic disk 206 to rotate the shaft 204 (to rotate the magnetic rotor 202).

The magnetic rotor 202 is responsible for generating a magnetic field for the generation of electricity through the process of electromagnetic induction. In some examples, the magnetic rotor 202 includes a permanent magnet. Permanent magnets may be constructed from neodymium or ferrite that retain their magnetic properties over time. In other examples, the magnetic rotor 202 may include electromagnets, which are coils of wire wound around a magnetic core. These electromagnets are energized with direct current (DC) to create a magnetic field. In some examples, the shape of the magnetic rotor 202 (or other permanent magnets) may include a cylindrical (or ring) shape. In other examples, the magnetic rotor 202 (or other permanent magnets) are another shape (with or without a central cutout for the shaft 204), e.g., square/rectangular shape. The magnetic rotor 202 is configured to rotate/spin with the shaft 204. As the magnetic rotor 202 rotates, the magnetic field around the magnetic rotor 202 changes which induces an electromotive force (EMF) or voltage in a wire (e.g. the stator coil 212). The rotating magnetic field may induce a changing magnetic flux in the stator coil 212 generating electrical voltage through electromagnetic induction. The speed of the rotation of the magnetic rotor 202 may influence the frequency and amplitude of the generated voltage. In some examples, voltage regulators may control the speed of the magnetic rotor 202 to maintain a stable output voltage.

Stator coil 212 contains coils of wire arranged to surround the rotating magnetic rotor 202. In some examples, the stator coil 212 is stationary around a moving/rotating magnetic rotor 202. The changing magnetic field induced by the rotating magnets or electromagnets in the magnetic rotor 202 generates a voltage in the stator coil 212. In some examples, the current generated by the stator coil 212 is an alternating current (AC).

As a brief aside, alternating current (AC) and direct current (DC) are two fundamentally different ways of transmitting and using electrical energy. AC voltage periodically reverses direction. It continuously alternates between positive and negative cycles, creating a sinusoidal waveform. In contrast, DC voltage is unidirectional, meaning it flows in a constant direction from positive to negative terminals. AC is typically used for transmission and distribution because it can be easily transformed into different voltage levels using transformers. It is also used in most household and commercial electrical systems because it is easy to generate and distribute. Conversely, DC circuits are generally simpler; for example, a DC motor can vary speed and provides consistent torque (both of which are difficult to do with AC motors). DC circuits are commonly used in hand tools, electronic devices (like smartphones and laptops), automotive systems, and some specialized applications like solar photovoltaic systems.

The induced AC voltage in the stator coil 212 represents the electrical output of the generator 200. This alternating current can then be used to power electrical loads directly and/or converted to direct current (DC) using a rectification circuit 218. The stator coil 212 may be constructed from wire made of copper, aluminum, alloys or composite metals, or any other conductive material that allows the flow of electrical current. Selection of the material may be based on the electrical conductivity, mechanical strength, and thermal stability of the material, and application (output, use case) of the generator 200.

Rectification circuit 218 may convert alternating current to direct current. In some exemplary uses, AC power at a very high frequency (Hz) may be rectified to DC for use. In some examples, the rectified DC power is later converted from DC back to a lower frequency AC power. Rectification circuit 218 may include diodes to convert AC to DC to allow current to flow through in one direction and blocking current flow in the reverse direction). Some examples use half-wave rectification and other examples use full-wave rectification to perform the conversion. Half-wave rectification passes only the positive half-cycles of the AC signal. Full-wave rectification uses both positive and negative half-cycles of the AC signal. In some examples, a bridge rectifier may be used to perform full-wave rectification. Rectification circuit 218 may include a filter capacitor configured to smooth the pulsating DC output. The filter capacitor may output more stable and usable DC voltage.

In some embodiments, the generator 200 may incorporate additional rectifiers, inverters, and/or transformers. An inverter does the opposite of a rectifier; it “inverts” DC voltage into AC voltage. Inverters generate a sinusoidal or modified sine wave AC output. Transformers can be used to increase (step-up) or decrease (step-down) the voltage level of an AC voltage without changing its frequency.

Transformers have a variety of useful properties. First, transformers may be used to match the voltage of electrical equipment to the available supply voltage. For example, industrial equipment may require a specific voltage level that differs from the standard distribution voltage. Secondly, transformers may be used to match the impedance between two components of a circuit, optimizing power transfer. Thirdly, transformers can introduce a controlled phase shift between the input and output voltages. This property is used in various applications, including power factor correction and inductive coupling in electronic circuits.

Load 214 may include any device connected to the generator 200 that consumes electrical power. Upon connection of the load, electric current may begin to flow from the generator 200 through the load 214. The impedance or resistance of the load 214 may determine the amount of current that flows through the circuit. Thus, the rotational velocity of the magnetic rotor 202 may be adjusted by the resistance of the load 214. The load 214 may include a voltage regulator to maintain consistent/optimal power from the generator. Current may be consumed by the load 214. Remaining current may be sent through coiled wires 216 to form an electromagnet in the driver magnets 210. The strength of the electromagnet may be based on the remaining current. As a result, the load 214/voltage regulator may alter the speed of rotation of the shaft 204/magnetic rotor 202. For example, a relatively larger load 214 may cause the rotational velocity of the shaft 204/magnetic rotor 202 to decrease, whereas a relatively smaller load 214 may cause the rotational velocity of the shaft 204/magnetic rotor 202 to increase.

Based on the size of the generator 200 and the size of the magnets (e.g., magnetic rotor 202, magnetic disks 206, and driver magnets 210), the generator 200 may have an optimal frequency/rotational velocity (or an optimal frequency window) for maximum power output. This optimal frequency may balance the power output with the power used to amplify the magnet field of the electromagnets in the driver magnets 210. The voltage regulator may alter the amount of the load 214 to maintain an optimal frequency (or maintain a frequency within an optimal window) of the shaft 204/magnetic rotor 202. Changing the load 214 may allow the generator 200/voltage regulator to regulate the rotational speed of the shaft 204. In some examples, the rotational velocity (and/or the optimal rotational velocity) of the shaft 204/magnetic rotor 202 may reach or even exceed 100,000 rpm.

In a specific example, the DC current output from the rectification circuit passes over the two windings placed around driver magnets 210 to amplify the magnetic field generated by the electromagnets of the driver magnets 210. In turn this increases the rotational velocity of the shaft 204 based on the rotation of the magnetic disks 206. When the circuit is closed over the load 214, a self-excitation circuit may be created which may exponentially increase the rotational rate (frequency) of the magnetic rotor 202. As a brief aside, a “closed” electrical circuit provides a path for electric current to flow from a power source across a load; an “open” electrical circuit means that the path from a power source to a load has a gap which prevents the flow of electrical current.

A self-excitation circuit may allow the generator 200 to build up its own excitation or field current without the need for an external power source. This may allow the generator 200, particularly at startup, to increase the rotation of the magnetic rotor 202. The self-excitation circuit may be used to regulate the frequency of the magnetic rotor 202/shaft 204. An Automatic Voltage Regulator (AVR) may control and regulate the output voltage of the generator 200. In some examples, the AVR monitors the output voltage and adjusts the excitation current to maintain a constant and stable voltage level, compensating for changes in load 214 and other operating conditions.

An electronic monitoring system may be used to control and monitor the frequency and output voltage of the generator 200. The electronic monitoring system may regulate how much (DC) voltage is applied to the coiled wires 216 of the driver magnets 210 to maintain the optimal rotational speed of the generator 200. The electronic monitoring system may include a processor and a non-transitory computer-readable medium that stores program instructions and/or data. More specifically, the electronic monitoring system may include one or more controllers, general-purpose processors, graphics processors (GPUs), neural network processors (NPUs), image signal processors (ISPs), digital signal processors (DSPs), modems, networking processors, field programmable gate arrays (FPGAs), codecs, application specific integrated circuits (ASICs), and/or any other semiconductor logic. Such computing devices may be combined with other circuitry (e.g., data storage circuitry, sensors, other signal processing components) on one or more printed circuit boards (PCBs) within the generator 200.

Various embodiments of the present disclosure may incorporate power conditioning techniques to ensure that produced power does not exceed acceptable tolerances, the rate of change does not exceed acceptable tolerances, and has (or does not have) certain frequency characteristics. As but one example, voltage and/or current regulation may ensure that overvoltage/undervoltage does not damage connected loads 214 or other circuitry of the generator 200. Furthermore, additional resistance, capacitance, and/or inductance may be added to filter out problematic resonant frequencies. Non-linear components (such as Zener diodes, etc.) may also be used to ensure that excess power is diverted from sensitive circuits. Frequency regulation may be used to stabilize frequencies, or synthesize additional frequencies.

Efficiently converting the torque generated by the driver magnets 210 to rotation of the magnetic disks 206 may allow the generator 200 to generate electricity more efficiently. Stabilization of the shaft 204/magnetic disks 206 may allow the generator 200 to efficiently induce rotation of the magnetic disks 206 and to convert that rotation to electrical power. Stabilization also allows the moving parts of the generator 200 to operate safely.

In some examples, the magnetic disks 206 may be held in place with the passive magnetic bearings 220. Passive magnetic bearings 220 may include magnets to allow for the stable levitation and rotation of the shaft 204. This passive technique may enable stabilization of the shaft 204/magnetic disks 206 without the need for active control systems or external power sources. The passive magnetic bearings 220 may provide axial stabilization to support the weight of the shaft 204 allowing rotation about the central axis of the shaft 204 (e.g., pitch) while inhibiting other axial movements of the shaft 204 (e.g., bending, stretching, pushing, pulling, bouncing, swinging, shaking and/or twisting). The passive magnetic bearings 220 may also provide radial (dynamic) stability, inhibiting other rotation (e.g., roll, yaw) and translational movement of the shaft 204.

The passive magnetic bearings 220 may include permanent magnets (with, e.g., a constant magnetic field) arranged in a way that creates a stable magnetic field around the rotating shaft 204. The passive magnetic bearings 220 may be positioned about the shaft 204 to lift the magnetic rotor 202 and create a (near) frictionless surface for the shaft 204 to rotate (via an airgap 222).

For example, permanent magnetic bearings (PMB) may be used. In this example, rotor magnets 224 may be arranged on the shaft 204 in a ring. The rotor magnets 224 on the shaft 204 may rotate in tandem with the shaft 204. Stator magnets 226 may be arranged in a complementary ring separated by an airgap 222. The stator magnets 226 may be fixed in place and do not move with the shaft 204. The rotor magnets 224 and the stator magnets 226 may be arranged with alternating polarities. The alternating polarities may create a magnetic field pattern that induces repulsive and attractive forces between them. The arrangement is such that like poles face each other, leading to repulsion, while opposite poles face each other, leading to attraction.

Various magnetization schemes (e.g., polarity placement) and configurations of the rotor magnets 224 and stator magnets 226 may be used as would be understood by those of ordinary skill in the art. For example, a planar PMB may be used that includes an axial airgap separating planar magnets (rotor magnets 224 and the stator magnets 226) with multiple polarities within each planar magnet. The polarities of the planar magnets may be arranged in a Halbach array. In another example, a radial ring PMB may be used that may include radially oriented bearings with two ring-or cylindrical-structures nested inside one another (the rotor magnets 224 nested inside the stator magnets 226) with a radial airgap 222. In another example, an axial ring PMB may be used that includes a ring magnet configuration with an axial airgap between interacting rings of rotor magnets 224 and stator magnets 226. In a further example, a conical PMB may be used where the rotor magnets 224 nested inside the stator magnets 226 are nested cones.

In another example, the magnetic disks 206 act as the rotor magnets 224 and stator magnets 226 are arranged around the magnetic disks 206 such that the magnetic disks 206 are able to rotate (with the shaft 204) while maintaining stability (by inhibiting movement in other directions).

Other stabilization techniques (both active and passive) may be used with equal success based on the requirements of the generator 200, e.g., weight of the components, tolerance of allowable friction. Such techniques may include superconducting magnetic bearings (SMB), active magnetic bearings (AMB), hydrodynamic bearings, fluid film bearings, flexure bearings, piezoelectric bearings, elastomeric bearings, etc.

The shaft 204 and magnetic rotor 202 as well as driver magnets 210 are subject to gravitational forces and the forces from the passive magnetic bearings 220. In addition, in the axial direction driver magnets 210 exert force on the magnetic discs 206 positioned at the ends of the shaft 204-magnetic rotor 202 system. Rescue bearings 228 may keep the rotor assembly (e.g., the shaft 204/magnetic rotor 202) from translating horizontally (e.g., sway) beyond a threshold tolerance. In some examples, during operation where the shaft 204 remains stable, the rescue bearings 228 are not in contact with the shaft. However, if the shaft 204 becomes unstable (e.g., in the event of axial disequilibrium), the rescue bearings 228 may make contact with the shaft 204. In such an instance the horizontal movement of the shaft 204 will be stopped by the rescue bearings 228.

FIG. 3 is a cross-sectional view of exemplary rescue bearings 228, as shown in FIG. 2. To address potential disequilibrium in the axial direction on both sides of the shaft 204 rescue bearings 228 may be installed. The rescue bearings 228 are not engaged in normal operation; merely in the event of an axial disequilibrium. The ends 208 of the shaft 204 may end in a conical tip 302. Opposing the conical tip 302 are contact blocks 304. In some examples, the contact blocks are disks. In some examples, the conical tip 302 includes a tungsten carbide (widia) point at the ends of the shaft 204 and the contact blocks 304 include tungsten carbide/widia. Other materials may be used to construct the conical tip 302 and/or the contact blocks 304, e.g., other hard substances such that there is little friction in the case of contact between the conical tip 302 and the contact block 304.

Power output from the generator 200 may be estimated based on the rotational energy of a rotating object is a squared function of the number of rotations per minute (rpm), specifically the square of the angular velocity of the rotor. For a cylindrical aluminum rotor with a radius of 10 cm (with a shaft hole having a 0.75 cm radius) and height of 10 cm, rotating at 10,000 rpm:
R₁: 10 cm=10⁻¹ m
H: 10 cm=10⁻¹ m
V₁=πR₁²H=π(10 cm)²(10 cm)≈3140 cm ³
R₂: 0.75 cm=7.5×10⁻² m
V₂=πR₂²H=π(0.75 cm)²(10 cm)≈17.66 cm ³
Vᵣₒₜₒᵣ=V₁−V₂=3122.33 cm³
m=Vᵣₒₜₒᵣ×d_{Al}=3122.33 cm³×(2.7 g/cm³)=8430 g=8.430 kg
Θ=¼m(R₁²+R₂²)+(1/12)mH²=¼×8.430×(10⁻²+5.625×10⁻³)+(1/12)×8.430×10⁻²=2.1075×1.5626×10⁻²+8.430*10⁻²/12=3.216×10⁻²+0.720×10⁻²=3.918×10⁻² kgm²
S_{R}: 10,000 rpm
f=S_{R}/60 ≈166.67/s
ω=2πf≈6.28318×166.6/s≈1047.2 rad/sec

Eᵣₒₜ=½Θω²=½×(3.918×10⁻² kgm²)×(1047.2 rad/sec)²≈21,482.8 J
Estimated electric power output: 8,593.1 W
   where:
R₁ is the radius of the rotor;
H is the height of the rotor;
V₁ is the volume of the rotor (without the shaft hole);
R₂ is the radius of the shaft hole of the rotor;
V₂ is the volume of the shaft hole of the rotor;
Vᵣₒₜₒᵣ is the volume of the rotor;
m is the mass of the rotor;
d_{Al} is the density of aluminum;
Θ is the moment of inertia (of a rectangular shaped rotor magnet);
S_{R} is the speed of rotation of the rotor;
f is the frequency of the rotor (in rotations/second);
ω is the angular frequency (in radians); and
Eᵣₒₜ is the rotational energy of the rotor.

It is estimated that 30-40% of the rotational energy is converted to electricity.

Generators with much larger rotational velocity than what was calculated (e.g., 100,000 rpm or above) may output many hundreds of kilowatts. This may permit electrification of the surface and a fraction of the maritime transportation sectors. The aerospace industry also has a need for autonomous, point-of-use power generators.

### 3 Methods

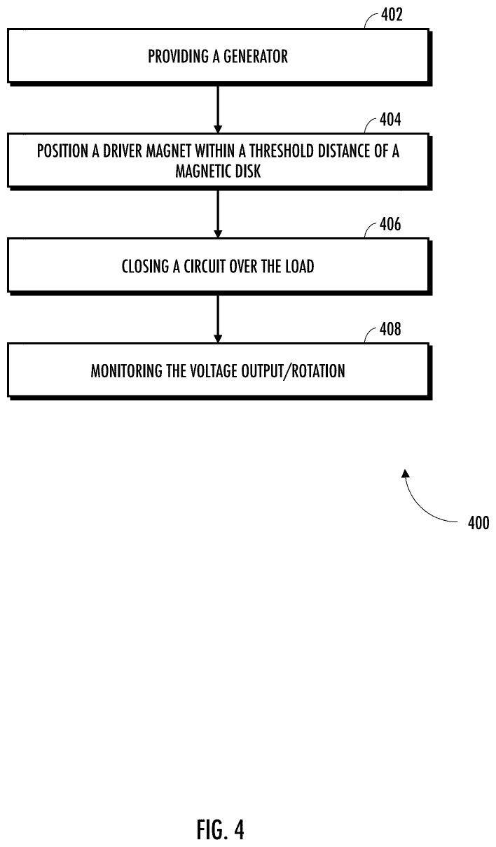

FIG. 4 is a logical flow diagram of an exemplary method 400 of using a permanent magnet motor. At step 402, a generator may be provided. The generator may include the generator 200 described with reference to FIG. 2.

At step 404, a driver magnet may be positioned within a threshold distance of a magnetic disk coupled to a shaft of the generator. The positioning of the driver magnet within the threshold distance may be via a user or via a machine. The driver magnet may induce rotation in the magnetic disk and the shaft. A magnetic rotor coupled to the shaft may rotate with the magnetic disk and the shaft. The magnetic rotor may induce an electric current in a stator coil.

At step 406, a circuit may be closed over a load resistance. A proper load may be selected to optimally operate the generator (or restart the generator after a period of non-use). Connecting the load to the circuit may allow the current to flow through the stator coil for output and to use as part of the self-excitation circuit to amplify the torque.

At step 408, output voltage of the generator and the rotational velocity of the shaft/magnetic rotor may be monitored and controlled for optimal electricity generation. Self-excitation circuitry may be used to increase the output power or rotational velocity of the rotor. The load resistance may be selected/re-selected to adjust the rotational velocity of the rotor.

### 4 Implementations

Aspects of the present disclosure relate to the generation of electric power. As would be appreciated by those of ordinary skill, aspects of the present disclosure may be scaled up to generate power of various needs and

In some examples, aspects of the present disclosure may be used to power homes off-grid or to supplement grid-power (in case of, e.g., blackouts). In one example, the generator includes one or more sockets/outlets to access the power generated. In other examples, aspects of the present disclosure may be used to power larger areas (e.g., neighborhoods/cities/regions) as part of a power plant. In such cases, as would be understood by those of ordinary skill, larger magnets (e.g., in the magnetic rotor, driver magnets, etc.) may be used to generate more power. Additionally, multiple generators may be combined together to get more power.

In other examples, aspects of the present disclosure may be used to power transportation. For example, an automobile may include an electric generator to power or supplement power to the on-board battery or directly to the electric drivetrain (of an electric vehicle). In train, ship, or airplane applications, an electric generator may be the main source of power to the train, provide auxiliary power generation, or replace a diesel engine in a diesel-electric train or an auxiliary power unit (APU) in a large aircraft.

Aspects of the present disclosure may also be used in novelty applications (e.g., executive desk toys). A user may view the shaft/rotor turning in a miniaturized application.

### 5 Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A generator comprising:
a shaft having a first end and a second end;
a magnetic rotor coupled to the shaft;
a first magnet disposed on the first end of the shaft;
a second magnet disposed on the second end of the shaft, where the shaft, the magnetic rotor, the first magnet, and the second magnet are configured to rotate in tandem;
a stator coil surrounding the magnetic rotor, the stator coil configured to generate electricity when the magnetic rotor rotates within the stator coil;
a first driver magnet configured to induce first rotation in the first magnet in a first direction;
a second driver magnet configured to induce second rotation in the second magnet in the first direction, where the first rotation of the first magnet and the second rotation of the second magnet cause a third rotation of the magnetic rotor within the stator coil; and
a load electrically coupled to the stator coil.

2. The generator of claim 1, where:
the first magnet characterized by a first north pole and a first south pole,
the second magnet characterized by a second north pole and a second south pole,
the first driver magnet characterized by a third north pole and a third south pole,
the second driver magnet characterized by a fourth north pole and a fourth south pole,
the first north pole of the first magnet facing the third south pole of the first driver magnet, and
the second south pole of the second magnet facing the fourth north pole of the second driver magnet.

3. The generator of claim 1, further comprising:
a first contact block; and
a second contact block, where the shaft comprises a first conical tip disposed on the first end of the shaft and a second conical tip disposed on the second end of the shaft.

4. The generator of claim 3, where the first conical tip is configured to make contact with the first contact block during an axial disequilibrium of the shaft.

5. The generator of claim 1, further comprising passive magnetic bearings disposed on the shaft configured to provide radial stability to the shaft.

6. The generator of claim 1, where the first driver magnet comprises an electromagnet comprising a coil winding.

7. The generator of claim 1, further comprising:
a rectification circuit electrically coupled to the stator coil and configured to convert an alternating current to a direct current.

8. The generator of claim 7, where the first driver magnet comprises a coil winding, the coil winding electrically coupled to the rectification circuit and configured to receive the direct current forming an electromagnet.

9. The generator of claim 8, where:
the direct current amplifies a magnetic strength of the first driver magnet creating an amplified magnetic field, and
the amplified magnetic field induces further rotation in the first magnet.

10. The generator of claim 9, where the first driver magnet is configured to move along an axis of rotation of the shaft.

11. A motor comprising:
a shaft having a first end and a second end;
a magnetic rotor comprising a permanent magnet coupled to the shaft;
a first disk magnet disposed on the first end of the shaft;
a second disk magnet disposed on the second end of the shaft, where the shaft, the magnetic rotor, the first disk magnet, and the second disk magnet are configured to rotate in tandem;
a stator coil configured to generate alternating current electricity based on a first rotation of the magnetic rotor;
a first driver magnet configured to induce a second rotation in the first magnet in a first direction;
a second driver magnet configured to induce a third rotation in the second magnet in the first direction, where the second rotation of the first magnet and the third rotation of the second magnet cause the first rotation of the magnetic rotor within the stator coil; and
a load electrically coupled to the stator coil.

12. The motor of claim 11, where the magnetic rotor is magnetically suspended on the shaft.

13. The motor of claim 11, where the first driver magnet provides axial stability to the magnetic rotor and the shaft.

14. The motor of claim 11, further comprising passive magnetic bearings configured to provide radial dynamic stability to the magnetic rotor and the shaft.

15. The motor of claim 11, where the first driver magnet and the second driver magnet have opposing polarities.

16. The motor of claim 11, where the magnetic rotor begins spontaneous and accelerating rotation in response to the first driver magnet and the second driver magnet crossing a threshold distance from the first disk magnet and the second disk magnet.

17. A method of operating a permanent magnet motor, comprising:
providing the permanent magnet motor, the permanent magnet motor comprising a magnetic rotor and a magnetic disk coupled to a shaft and a driver magnet configured to induce rotation in the magnetic disk;
positioning the driver magnet within a threshold distance from the magnetic disk to induce rotation in the magnetic disk;
closing a circuit over a load resistance; and
monitor rotational velocity of the magnetic rotor.

18. The method of claim 17, further comprising increasing an output power of the permanent magnet motor via self-excitation circuitry.

19. The method of claim 17, further comprising selecting the load resistance to adjust the rotational velocity of the magnetic rotor.

20. The method of claim 17, further comprising increasing a magnetic field of the driver magnet to accelerate rotation of the magnetic rotor.
